(19) United States
(12) Patent Application Publication
(10) Pub. No.: US 2005/0101369 A1
(43) Pub. Date: May 12, 2005

(54) Gaming machine

(76) Inventor: Jason Meyer, Wollstonecraft (AU)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 11/005,129

(22) Filed: Dec. 6, 2004

Related U.S. Application Data
(63) Continuation of application No. 10/028,851, filed on Dec. 21, 2001.

(30) Foreign Application Priority Data
Dec. 21, 2000 (AU) PR3074

(51) Int. Cl. A63F 13/00

(52) U.S. Cl. 463/16; 463/13; 463/20

(57) ABSTRACT

A gaming machine that uses wildcards 20-24 to substitute for symbols within a randomly selected array 40 of symbols such that the appearance of a wildcard 20-24 in any winning combination carrying a bet multiplies the usual winnings by a predetermined multiplying factor 25-27 associated with the wildcard 20, 21 and 24.

### CROSS REFERENCE TO RELATED APPLICATIONS

This is application is a continuation application of U.S. patent application Ser. No. 10/028,851, filed Dec. 21, 2001, entitled “GAMING MACHINE”, the entirety of which is incorporated herein by reference.

### BACKGROUND OF THE INVENTION

The present invention relates to gaming machines. The invention has been developed primarily for computerized gaming machines such as stand alone “poker machines” or Internet facilitated gaming. In light of the prevalence of these forms of gaming, the invention will be described herein with reference to that application. However, the invention is not limited to this and may be suitable for many other applications.

Gaming machines have long been known and are now one of the most common forms of gambling. Usually gaming machines will simulate a well-known game of chance. One of the oldest and best known forms of gaming machine is the rotating reel type “poker machine”.

Poker machines use a series of three, four or five reels, each reel having symbols on its peripheral edge. The reels are rotated upon the placement of a bet and then stopped to produce an array of randomly arranged symbols. Winnings are paid if the random arrangement of symbols matches one of the predetermined winning combinations.

Gaming machines can “pay winnings” in a variety of ways. These include dispensing money, dispensing tokens that can be redeemed for money, or simply adding credits to a credit meter that can be used for placing future bets or redeemed as money. More recently these gaming machines have been computerized in the form of stand alone machines or simulations of the stand alone machines accessible via the Internet. Computerized machines usually award winnings in the form of credits tallied on a credit meter. In light of their wide spread use, the invention will be described in the context of this type of winnings payment mechanism. However those skilled in the art will readily understand that the term encompasses other many payment mechanisms.

Computerized gaming machines use a video screen display instead of physically rotating reels. The display typically presents an array of symbols in five columns and three rows equating to the symbols that would normally be seen on the five physically rotating reels of an old style mechanical machine. Computerized machines have allowed players to simultaneously bet on the combination of symbols appearing in many different part of the array. These parts of the array are often referred to as “paylines” consisting of lines of adjacent symbols extending through the array. The symbols may be laterally adjacent each other (as in from the same row) or diagonally adjacent each other. They usually extend along each row as well as various angled or “zigzag” lines through the array. This provides a more interesting and exciting game than the old style mechanical machines which traditionally only offered a single payline through the middle row.

A common feature on gaming machines of this type is the use of “wildcards”. Wildcards are well known in many card games as cards that have been designated as substitutes for other cards. Similarly, wildcard symbols appearing in the array of symbols on a gaming machine can substitute for other symbols.

The appearance of a wildcard on any paylines carrying a bet is beneficial as it increase the probability of forming a winning combination. Wildcards can also provide an incentive for players to place bets on most, if not all, the available paylines. Each symbol in the array will usually be part of more than one payline. Therefore, the probability of a winning payline (that is, a payline which carries a bet and shows a winning combination of symbols) is significantly increased if one or more wildcards appear in an array in which the player has bet on all available paylines.

Despite these significant benefits, players are now very familiar with the wildcard feature and its appearance in an array of symbols does not provide a strong sense of bonus or incentive for many seasoned players.

It is desirable to have a gaming machine which overcomes or ameliorates these disadvantages.

### SUMMARY OF THE INVENTION

In accordance with the present invention, there is provided a gaming machine which overcomes or ameliorates at least one of the disadvantages of prior gaming machines and provides a useful alternative.

Further, in accordance with the present invention, there is provided a gaming machine comprising:
means adapted to display an array of symbols randomly selected from a set of symbols; means adapted to paying winnings on an occurrence of predetermined winning combinations of symbols appearing in predetermined portions of the array, wherein the set of symbols comprises at least one wildcard which can substitute for any other symbol in the set in order to form at least one of the winning combinations; and
in response to a predetermined trigger event, means adapted to increase the winnings normally paid on any winning combination which is comprised of at least one wildcard.

Still further, in accordance with the present invention, there is provided a method for operating a gaming machine comprising:
displaying an array of symbols randomly selected from a set of symbols;
paying winnings on an occurrence of predetermined winning combinations of symbols appearing in predetermined portions of the array, wherein the set of symbols comprises at least one wildcard which can substitute for any other symbol in the set in order to form at least one of the winning combinations; and
in response to a predetermined trigger event, paying winnings in addition to those normally paid on any winning combination which is comprised of at least one wildcard.

Preferably, the predetermined portions of the array are paylines, any paylines carrying a bet and showing a winning combination is a winning payline and the predetermined trigger event is a designated combination of the wildcards appearing in the array, such that the winnings normally paid on any winning paylines incorporating any of the wildcards from the designated combination are increased.

In another preferred form, the predetermined trigger event is a selceted relative positioning of at least two of the wildcards.

By configuring the machine such that certain combinations and/or configurations of wildcards will increase the winnings paid on winning paylines, the wildcard aspect of the game is more rewarding and therefore more interesting for players.

In some preferred forms, the designated combination must appear in adjacent positions of the array such that the combination is then presented as a single symbol that is larger than the remaining symbols within the array. This allows the appearance of the designated combination to have a strong visual impact which reinforces to the player that it provides increased winnings.

In further preferred forms, the designated combination also includes symbols from the set other than the wildcard symbols. By allowing non-wildcard symbols to form part of the designated combinations, the game designer can have the designated combination appear more frequently without needing to use a set of symbols with relatively large numbers of wildcards. It will be appreciated that increasing the number of wildcards in a set of symbols significantly increases the probability of winning combinations within the paylines. If this is the case, then the machine cannot afford to be too generous with the winnings that it pays without compromising the profit from the machine.

Preferably, each of the wildcards in the combination are individually assigned a multiplying factor such that whenever one of the wildcards appears in a winning payline, the win normally paid is multiplied by the multiplying factor. In other preferred embodiments, the multiplying factors are randomly selected from a preset range.

In some embodiments, the multiplying factor is related to, or otherwise linked to, the total number of wildcards that appear in the array. Preferably, all wildcard symbols have a multiplying factor whenever they appear in the array such that in response to the trigger event, winning paylines with at least two of the wildcards have their multiplying factors added or multiplied together to give a larger multiplying factor which is applied to the usual winnings of the winning payline.

In this form, the returns to the player would be particularly generous and this provides a strong incentive to continue playing the machine. This is especially so if the trigger event is designated combination which incorporates non-wildcard symbols and the multiplying factor calculated for the wildcards within the designated combination is also applied to the non-wildcard symbols within the designated combination.

In some particularly preferred forms, the array has more than five columns of symbols and/or more than three rows of symbols. It will be appreciated that an oversized symbol appearing in a larger array will have more visual impact.

These and other aspects of the present invention will be understood by one of ordinary skill in the art upon the reading and understanding of the specification.

### BRIEF DESCRIPTION OF THE DRAWINGS

Preferred embodiments will now be described, by way of example only, with reference to the accompanying drawings in which:

FIG. 1 is a schematic representation of the display screen of a gaming machine according to the present invention; and

FIG. 2 is a schematic representation of the display screen of a gaming machine according to another form of the present invention.

### DETAILED DESCRIPTION OF THE PREFERRED EMBODIMENTS

Referring to the figures, the gaming machine displays an array of symbols 40 arranged in five columns and seven rows. The columns are presented on the display screen as simulations of reels 41, 42, 43, 44 and 45, which spin to randomly arrange the symbols within the array 40. The set of symbols includes several wildcards 20, 21, 22, 23 and 24, which can substitute for any of the other symbols in order to form a winning combination of symbols on a payline carrying a bet.

The array 40 has paylines 1-1 through 19-19 available for placing a bet. The various winning combinations and the credits awarded for a minimum bet on each is tabulated somewhere on the screen or facia. This table is commonly referred to as the “paytable” or “scorecard”. As is typical in the industry, the gaming machine portrays a particular theme or motif on the machine facia and through aspects of the game itself. For example, the theme may be related to Olympic competition, whereby the three different types of wildcard are depictions of gold, silver, or bronze medals.

Upon the occurrence of a winning combination in a payline carrying a bet (that is, a winning payline), the machine will pay winnings calculated from the amount wagered on the payline and the payout level shown on the scorecard.

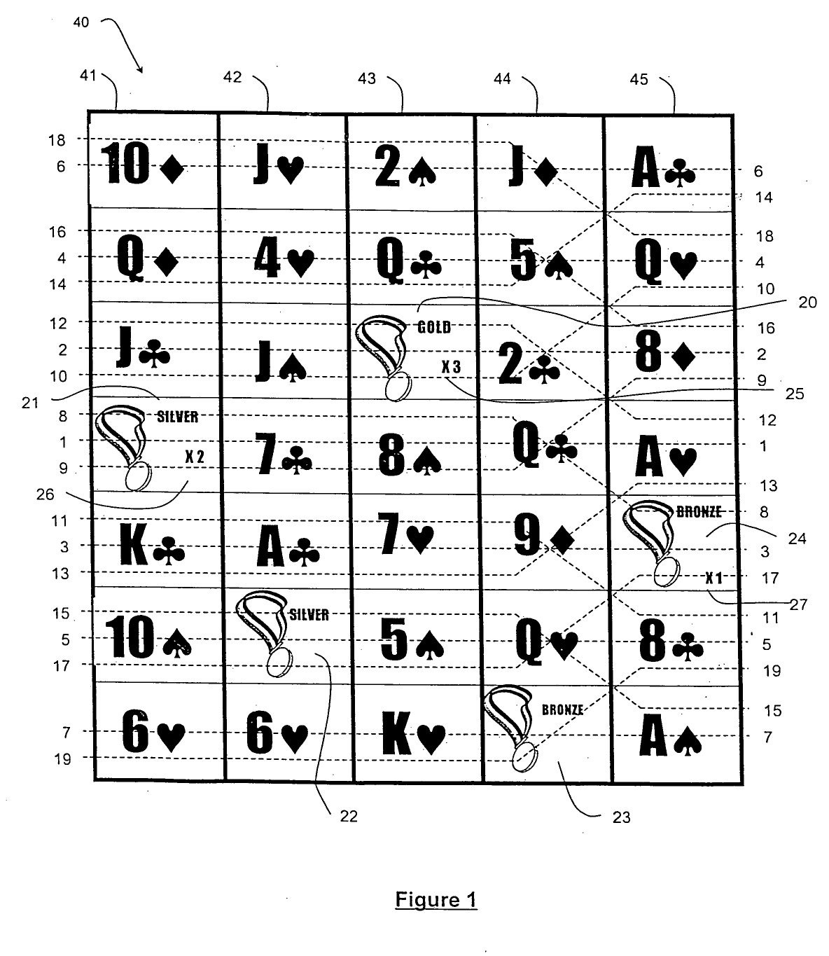

If a wildcard appears in a payline carrying a bet, the players' chances of a winning payline are improved as the wildcard substitutes for any of the other symbols. As shown in FIG. 1, the machine is also configured so that certain combinations of wildcards will yield their own benefit in addition to the winning paylines. In this case, a gold/silver/bronze wildcard combination scattered anywhere in the array 40 gives each wildcard in the combination 20, 21 and 24, a multiplying factor 25, 26 and 27 respectively. A multiplying factor multiplies the winnings normally received for any winning paylines incorporating that wildcard.

The multiplying factors may be fixed whereby gold wildcards will always be assigned on multiplying factor of 3 while silver and bronze are assigned multiplying factors of 2 and 1.5 respectively. The multiplying factors may also be randomly selected from a predetermined range of multiplying factors, say 1 to 5.

Alternatively, certain wildcard combinations suitably simply add a set amount of bonus credits to any winnings from the winning paylines or provide some other type of potential benefit to the player. This will be at the discretion of the game designer in light of the desired “volatility” of the game.

The volatility of a gaming machine refers to the expected frequency of wins and corresponding amount paid for each win. Over time, all gaming machines return a set percentage of the bets received as winnings. However, a machine with high volatility will return this percentage though fewer wins of higher value as opposed to a low volatility machine providing more wins of less value. By giving the wildcards the ability to influence the winnings paid when they appear in a winning hand they can be used to adjust the volatility of the gaming machine to any desired level.

If at least two wildcards appear in the same winning payline, it is a simple matter for the game designer to determine how the winnings will be affected in order to maintain the desired level of volatility. The multiplying factors may be added together or multiplied together before being applied to the winnings of the winning payline. Alternatively, the game may simply use the highest multiplying factor and ignore any others.

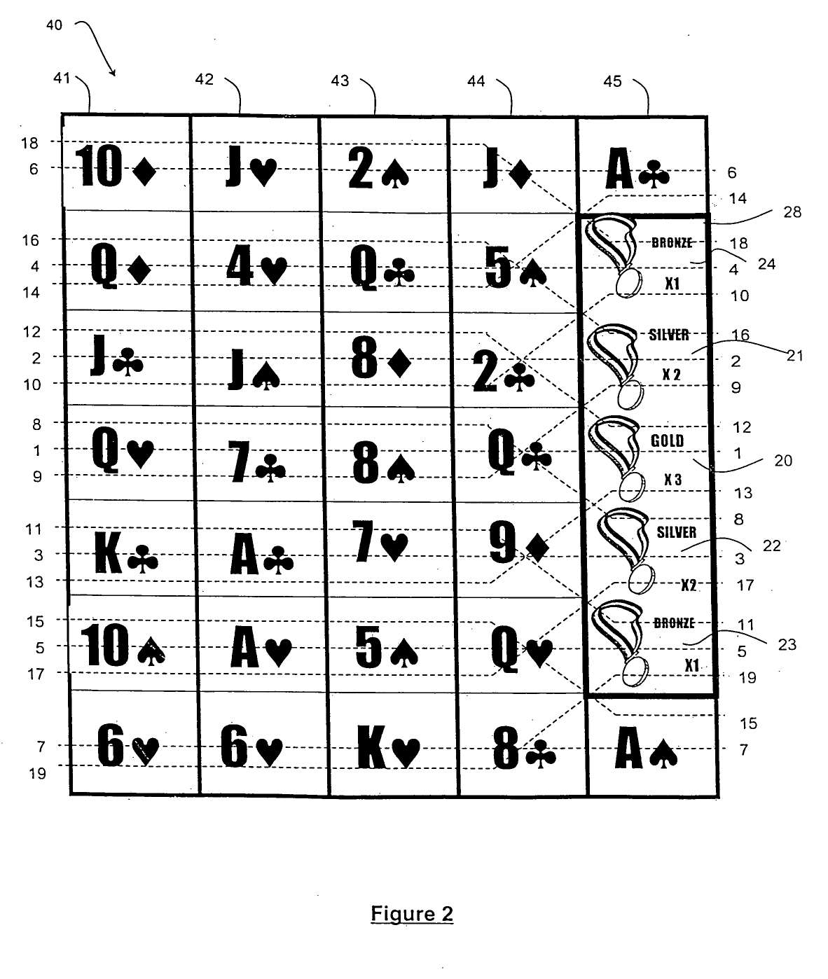

Referring to FIG. 2, the game is configured so that whenever the wildcards 20 to 24 are adjacent each other on a single reel 45, they are graphically merged and presented as a single oversized wildcard symbol 28. While the wildcards 22 to 24 are shown as a single oversized symbol, they still have individually assigned multiplying factors which will effect only those winning paylines incorporating the individual wildcard. However, the game designer may wish to apply a single multiplying factor to the entire oversized wildcard 28. Again this may be predetermined or randomly selected depending on the desired level of volatility.

Furthermore, the adjacent wildcard symbols need not be on the same reel. The wildcards may be next to each other on adjacent reels and the predetermined combination of symbols required form an oversized wildcard need not consist only of the individual wildcard symbols. The game designer may wish to incorporate other symbols from the array. Of course, this also influence volatility.

By adding an extra benefit to wildcard in response to a trigger, the well known and accepted wildcard aspect is given an additional dimension. It allows a game where players not only look to achieve certain combinations of the ‘regular’ symbols, but also certain combinations of the wildcard symbols and or certain arrangements of the wildcard symbols.

If the wildcard greatly increases the winnings paid, then its occurrence in a payline carrying a bet is more likely to give the player a strong sense of bonus. By using adjacent sets of wildcards in the array, they can have greater visual appeal and impact. Furthermore, they can significantly increase any winning amounts, especially if all available paylines are played. This provides a strong incentive for the player to maximixe the number of paylines played which tends to increase the amount they bet. This, in turn makes the machine more profitable for the owner.

The invention has been described herein by way of example only. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

1. A gaming machine comprising:
means adapted to display an array of symbols randomly selected from a set of symbols;
means adapted to paying winnings on an occurrence of predetermined winning combinations of symbols appearing in predetermined portions of the array, wherein the set of symbols comprises at least one wildcard which can substitute for any other symbol in the set in order to form at least one of the winning combinations; and
in response to a predetermined trigger event, means adapted to increase the winnings normally paid on any winning combination which is comprised of at least one wildcard.

2. A gaming machine according to claim 1 wherein the predetermined portions of the array are paylines, wherein any paylines carrying a bet and showing a winning combination is a winning payline, and wherein the predetermined trigger event is a designated combination of the wildcards appearing in the array such that the winnings normally paid on any winning paylines incorporating any of the wildcards from the designated combination are increased.

3. A gaming machine according claim 1 wherein the predetermined trigger event is selected relative positioning of at least two of the wildcards.

4. A gaming machine according to claim 2 wherein the designated combination must appear in the adjacent positions of the array such that the combination is then presented as a single symbol that is larger than the remaining symbols within the array.

5. A gaming machine according to claim 2 wherein the designated combination also includes symbols from the set other than the wildcard symbols.

6. A gaming machine according to claim 2 wherein all wildcard symbols have a multiplying factor, and wherein in response to a trigger event and when at least two wildcard appear in select winning paylines, the multiplying factors of the at least two wildcards are at least one of added together and multiplied together to produce a larger multiplying factor which is applied to the normal winnings of such winning payline.

7. A gaming machine according to claim 6 wherein the multiplying factors are randomly selected from a preset range.

8. A gaming machine according to claim 6 wherein the multiplying factors are related to the total number of wildcards that have appeared in the array.

9. A gaming machine according to claim 2 wherein all wildcard symbols have a multiplying factor, and wherein in response to a trigger event and when at least two wildcard appear in any winning paylines, the multiplying factors of the at least two wildcards are at least one of added together and multiplied together to produce a larger multiplying factor which is applied to the normal winnings of the winning payline.

10. A method for operating a gaming machine comprising:
displaying an array of symbols randomly selected from a set of symbols; paying winnings on an occurrence of predetermined winning combinations of symbols appearing in predetermined portions of the array, wherein the set of symbols comprises at least one wildcard which can substitute for any other symbol in the set in order to form at least one of the winning combinations; and
in response to a predetermined trigger event, paying winnings in addition to those normally paid on any winning combination which is comprised of at least one wildcard.

11. A method according to claim 10 wherein the predetermined portions of the array are paylines, wherein any paylines carrying a bet and showing a winning combination is a winning payline, and wherein the predetermined trigger event is a designated combination of the wildcards appearing in the array such that the winnings normally paid on any winning paylines incorporating any of the wildcards from the designated combination are increased.

12. A method according claim 10 wherein the predetermined trigger event is selected relative positioning of at least two of the wildcards.

13. A method according to claim 11 wherein the designated combination must appear in the adjacent positions of the array such that the combination is then presented as a single symbol that is larger than the remaining symbols within the array.

14. A method according to claim 11 wherein the designated combination also includes symbols from the, set other than the wildcard symbols.

15. A method according to claim 11 wherein all wildcard symbols have a multiplying factor, and wherein in response to a trigger event and when at least two wildcard appear in select winning paylines, the multiplying factors of the at least two wildcards are at least one of added together and multiplied together to produce a larger multiplying factor which is applied to the normal winnings of such winning payline.

16. A method according to claim 15 wherein the multiplying factors are randomly selected from a preset range.

17. A method according to claim 15 wherein the multiplying factors are related to the total number of wildcards that have appeared in the array.

18. A method according to claim 11 wherein all wildcard symbols have a multiplying factor, and wherein in response to a trigger event and when at least two wildcard appear in any winning paylines, the multiplying factors of the at least two wildcards are at least one of added together and multiplied together to produce a larger multiplying factor which is applied to the normal winnings of the winning payline.

19. A gaming machine comprising:
means adapted to display an array of symbols randomly selected from a set of symbols, wherein the set of symbols comprises at least one wildcard which can substitute for any other symbol in the set of symbols in order to form at least one winning combination, and wherein the wildcard is automatically displayed during a normal operation of the gaming machine;
means adapted for paying winnings on an occurrence of predetermined winning combinations of symbols appearing in predetermined portions of the array; and
means adapted for increasing the winnings normally paid on any winning combination which is comprised of at least one wildcard, wherein the amount paid on a winning combination of symbols having at least one wildcard is increased in response to a predetermined trigger event.
